(19) United States
(12) Patent Application Publication
(10) Pub. No.: US 2007/0269661 A1
(43) Pub. Date: Nov. 22, 2007

(54) Ultraproductive coating composition using a chemically mixed isocyanate system

(76) Inventor: William F. Graham, Wayne, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/803,945

(22) Filed: May 16, 2007

Related U.S. Application Data
(60) Provisional application No. 60/800,784, filed on May 16, 2006.

(51) Int. Cl. B32B 27/00; C08L 75/00; C08G 18/00

(52) U.S. Cl. 428/423.1

(57) ABSTRACT

This invention relates to coating compositions, and more particularly to highly productive coating compositions that quickly cure at ambient temperatures. Such coatings utilize as the crosslinking component, a mixture of a polyisocyanate adduct and at least one other polyisocyanate compound that is different than the adduct and are particularly useful for the coating of large vehicles such as, airplanes, buses, trains, recreational vehicles, farm machinery, heavy-duty trucks, and other large vehicles which are difficult to cure using conventional oven curing techniques.

### CROSS-REFERENCE TO RELATED APPLICATION

This patent application claims the benefit of U.S. Provisional Application Ser. No. 60/800,784 filed on May 16, 2006 which is hereby incorporated by references in its entirety.

### FIELD OF THE INVENTION

This invention relates to coating compositions, and more particularly to highly productive coating compositions that quickly cure at ambient temperatures. Such coatings are particularly useful for the coating of large vehicles such as, airplanes, buses, trains, recreational vehicles, farm machinery, heavy-duty trucks, and other large vehicles which are difficult to cure using conventional oven curing techniques.

### BACKGROUND OF THE INVENTION

Large transportation vehicles typically have several layers of finishes or coatings on their exterior bodies and body parts to provide protection against corrosion and an attractive aesthetic appearance. For example, the substrate is typically first coated with an inorganic rustproofing zinc or iron phosphate layer over which is provided a primer which can be an electrocoated primer. Optionally, a primer surfacer can be applied to provide for better appearance and/or improved adhesion. A single-stage pigmented basecoat or topcoat is then typically next applied over the primer to impart the desired appearance to the vehicle. This type of finish is usually referred to as a single-stage basecoat finish. The topcoat color-providing layer may be clear coated to provide durability to the color layer(s), but typically with large transportation vehicles, clearcoats or basecoat/clearcoat finishes are typically avoided due to the amount of time required to apply an additional coating layer to the tremendous-sized body. In general, the colored topcoat therefore has to satisfy the highest requirements in terms of appearance, gloss, distinctness of image (DOI), and resistance to solvents, chemicals, weathering and hydrolysis. In special applications, such as aircraft finishing, the coatings also need to be resistant to UV radiation, harsh chemicals such as aviation hydraulic fluids and fuel, and temperature extremes.

A manufacturer of large vehicles would like to have a coating composition that can be cured at ambient or only slightly elevated temperatures due to the size constraints of the vehicle being assembled. Currently, these coatings need to be dried with heat lamps or the use of enclosures that can be heated with forced hot air.

The production of large machinery is a labor-intensive time consuming procedure. Many of these large vehicles are painted in a multi-color scheme reflecting the corporate designs of the owning company or personal preference of the individual owner. Coating such multi-color vehicles compounds the problems associated with this process as the coating compositions currently available to the manufacturer have a dry to tape time which is measured in hours (typically 4-6 hours even when large amounts of catalyst are used to accelerate the curing). Manufacturers of this type of large equipment would benefit from productivity improvements in all areas of its manufacture.

It would be desirable to be able to formulate a coating composition that has short cure time so that a finish of the coating composition can be sanded or buffed or taped in a relatively short period after application, while still maintaining today's performance requirements, such as gloss, appearance, and DOI. It would also be desirable to formulate a coating composition that cures rapidly at ambient temperatures, optionally allowing a clearcoat layer to be applied thereto, without sacrificing productivity of the assembly operations for large transportation vehicles.

The novel coating composition of this invention has the aforementioned desirable characteristics.

### SUMMARY OF THE INVENTION

The present invention is directed toward an ultraproductive coating composition that comprises a film forming crosslinkable component and a crosslinking component.

The crosslinkable component is a film-forming resin, such as an oligomer, polymer, dispersed gelled polymer, or a combination thereof having functional groups that are capable of crosslinking with isocyanate functionality that are present in the crosslinking component.

The crosslinking component of the present invention is a mixture of (a) from 5% to 95% by weight based upon the total weight of the crosslinking component of a polyisocyanate adduct mixture and (b) from 95% to 5% by weight based upon the total weight of the crosslinking component of at least one other polyisocyanate compound that is different than (a).

The polyisocyanate adduct mixture (a) of the present invention is the reaction product of at least one aliphatic isocyanate trimer and at least one cycloaliphatic isocyanate trimer with a urea and/or biuret forming agent. The polyisocyanate adduct mixture has a molecular weight in the range of from 500 to 3,000, and an average isocyanate functionality of at least 4.

When dried at ambient temperatures or slightly elevated temperatures (such as 40° C. to 100° C.), the coating film produced therefrom exhibits a rapid dry-to-touch (dust-free) time and a much improved initial processability, resulting in a hard, tough film that is sandable and buffable shortly after application.

This invention is further directed to a process for producing a coating on the surface of a substrate, such as an aircraft or truck body or part thereof, wherein the process comprises:

(a) applying a layer of a pigmented basecoat on the substrate surface, which may be previously primed or sealed or otherwise treated;

(b) applying a layer of clearcoat on top of the pigmented basecoat, either wet-on-wet or after the basecoat has dried sufficiently to allow taping; and

(c) simultaneously curing the basecoat and clearcoat layers together, preferably in the range of from ambient to 100C, to form a basecoat/clearcoat finish on the surface of the substrate, wherein the clearcoat, basecoat and/or primer comprises the crosslinkable coating composition disclosed herein.

Also included within the scope of this invention is a substrate coated with the aforementioned coating composition.

### DETAILED DESCRIPTION OF THE INVENTION

All molecular weights referred to herein are determined by GPC (gel permeation technology) using polystyrene as the standard.

In this disclosure, the terms “isocyanate trimer” and “polyisocyanate trimer” mean a polyisocyanate containing isocyanurate and/or iminooxadiazine dione groups.

The terms “starting trimers” and “starting isocyanate trimer” mean the starting mixture of polyisocyanates which is used to prepare the urea- and/or biuret-containing polyisocyanate adduct mixtures and which contains an aliphatic isocyanate trimer, a cycloaliphatic isocyanate trimer and optionally other polyisocyanate adducts as described below.

The terms “urea- and/or biuret-containing polyisocyanate adduct mixture” or “polyisocyanate adduct mixture” are used interchangeably and unless otherwise indicated, describe a mixture of polyisocyanates containing one or more of an aliphatic isocyanate trimer and a cycloaliphatic isocyanate trimer and one or more of a urea- or biuret-containing reaction product of one of the isocyanate trimers with itself (e.g., one aliphatic isocyanate trimer molecule to another aliphatic isocyanate trimer molecule) or with the other isocyanate trimer (e.g., one aliphatic isocyanate trimer molecule to a cycloaliphatic isocyanate trimer molecule).

The term “urea and/or biuret forming agent” as used herein means a reagent that is capable of causing a reaction between two or more isocyanate groups to form a urea and/or biuret group by converting one of the isocyanate groups to an amino group. Preferred urea and/or biuret forming agents are water, tertiary alcohols and/or pivalic acid, preferably water. The urea and/or biuret forming agent is used in an amount sufficient to provide 0.01 to 0. 15 moles, preferably 0.025 to 0.12 moles and more preferably 0.03 to 0.1 moles of agent for each equivalent of isocyanate groups in the starting isocyanate trimers.

The linking groups that connect the isocyanate trimers to each other, preferably an aliphatic isocyanate trimer to a cycloaliphatic isocyanate trimer, are either urea groups or biuret groups. In this reaction, higher amounts of cycloaliphatic isocyanate trimers tend to increase the formation of products that are linked with a urea group. Most preferred are those polyisocyanate adducts that are linked with a single group. Also present in this mixture will be unreacted starting materials and linked compounds containing only aliphatic isocyanate trimers and linked compounds containing only cycloaliphatic isocyanate trimers. The exact composition will vary dependent upon the ratio of aliphatic to cycloaliphatic isocyanate trimers charged to the reactor, reaction temperatures, and other reaction conditions within the scope of this disclosure. Those skilled in the art will appreciate the difficulties of specifying the exact composition of the reaction product since a number of different reaction products will typically be produced.

The polyisocyanate trimer and isocyanate trimer are prepared from diisocyanate or triisocyanate monomers, preferably diisocyanate monomers. These products are commercially available under the Desmodur® trademark from Bayer and consist mainly of isocyanurate oligomers of a diisocyanate.

The term “ultraproductive” refers to the fact that a coating has a dry-to-tape time of less than about 1 hour when the coating has been applied to a suitable substrate and allowed to dry at ambient temperatures.

The term “dry-to-tape time” or “dry-to-tape” refers to the time in which a freshly applied coating can be masked with tape to apply a second coating either over top of the first coating or in close proximity to the first coating so that removing the tape from the masked portion will not appreciably affect the appearance of the coating underneath the tape.

The term “gloss retention after tape” refers to the percentage of gloss remaining on a film surface after a clear coating has been sprayed and dried over a previously taped basecoat layer. To determine the gloss retention after tape, a basecoat (color coat) was applied to a suitably prepared substrate and allowed to dry for a period of time (preferably 1 to 2 hours) at ambient temperature. The gloss of this dried basecoat was then measured using a glossmeter at a desired angle or series of angles and tape was applied directly to the basecoat and was left in place for 1 to 24 hours. The tape was then removed and a clearcoat applied over the entire basecoated panel and allowed to dry. The gloss of the now clearcoated surface was measured at the place where the tape had been placed using a glossmeter at the same angle or series of angles as was initially measured. The percentage of gloss remaining at a given angle was calculated by the formula;
[1-(glossᵢₙᵢₜᵢₐₗ−gloss_{after tape})/glossᵢₙᵢₜᵢₐₗ]×100
One skilled in the art would be able to chose a suitable glossmeter; one example is the BYK Glossmeter, available from BYK Gardner USA, Columbia, Md. This procedure is meant to simulate a real-world scenario of applying a series of accent colors to a substrate. An incompletely cured basecoat can show defects underneath the previously taped portion that can be seen visually and can be quantified by measuring the gloss retention after tape as described.

The urea- and/or biuret-containing polyisocyanate adduct mixtures of the present invention are prepared by reacting a reaction mixture comprising
a) from 10 to 90 parts by weight of at least one aliphatic isocyanate trimer and
b) from 90 to 10 parts by weight of at least one cycloaliphatic isocyanate trimer wherein the sum of a) and b) is 100 parts, based on the total parts of a) and b) and
c) 0.01 to 0.15 moles of urea and/or biuret adduct forming agents for each equivalent of isocyanate groups in the isocyanate trimers at a temperature of 50° C to 1 80° C.

The starting aliphatic and cycloaliphatic isocyanate trimers that are used herein to make the polyisocyanate adduct mixtures
a) have an average isocyanate functionality of at least 2.8, preferably at least 3.0 and more preferably at least 3.2; and
b) contain either isocyanurate or iminooxadiazine dione groups, or mixtures thereof provided that a total of at least 50 mole percent, preferably at least 60 mole percent and more preferably at least 75 mole percent of isocyanurate and iminooxadiazine dione groups must be present, based on the total moles of isocyanate adduct groups present in the starting isocyanate trimers. Other isocyanate adducts that may be present in the starting polyisocyanate trimers include uretidione, biuret, urethane, allophanate, carbodiimide and/or oxadiazinetrione groups.

As indicated above, each group may be present alone or in combination with the other. In one preferred embodiment iminooxadiazine dione groups are present in a mixture with the isocyanurate groups in an amount of at least 10 mole percent, preferably at least 15 mole percent and more preferably at least 20 mole percent, based on the total moles of iminooxadiazine dione and isocyanurate groups.

In one preferred embodiment, the starting isocyanate trimer comprises a mixture of aliphatic isocyanate trimer and cycloaliphatic isocyanate trimer, in a mole ratio in the range of from 3:1 to 1:10. More preferably, the mole ratio of aliphatic isocyanate trimer to cycloaliphatic isocyanate trimer in the starting polyisocyanate trimer mixture is in the range from 3:1 to 1:8. Most preferably, the mole ratio of aliphatic isocyanate trimer to cycloaliphatic isocyanate trimer in the starting polyisocyanate trimer mixture is in the range from 2:1 to 1:5. In a particularly preferred embodiment the aliphatic isocyanate trimer is the trimer of hexamethylene diisocyanate and the cycloaliphatic isocyanate trimer is the trimer of isophorone diisocyanate.

Polyisocyanate trimers used to make the polyisocyanate adduct mixtures according to the invention preferably have an NCO content of 10 to 25% by weight, more preferably 12 to 25% by weight and most preferably 15 to 25% by weight; and preferably have an upper limit for the functionality of 8, more preferably 7 and most preferably 6. The starting material to prepare the starting isocyanate trimers preferably contains at least 70% by weight, more preferably at least 80% by weight and most preferably at least 90% by weight of diisocyanates, preferably 1,6-hexamethylene diisocyanate is used to prepare the aliphatic isocyanate trimers and isophorone diisocyanate is used to prepare the cycloaliphatic isocyanate trimers. Other polyisocyanate adducts that may be present in admixture with the starting isocyanate trimers include polyisocyanates containing uretidione, biuret, urethane, allophanate, carbodiimide and/or oxadiazinetrione, preferably uretidione, biuret, urethane and/or allophanate groups. While other isocyanate adduct groups may be present, a total of at least 50 mole percent, preferably at least 60 mole percent and more preferably at least 75 mole percent of isocyanurate and iminooxadiazine dione groups must be present, based on the total moles of isocyanate adduct groups present in the starting isocyanate trimers.

Polyisocyanate trimers containing isocyanurate groups and methods and catalysts for their preparation are known and can be prepared in accordance with the teachings of U.S. Pat. No. 4,324,879, herein incorporated by reference. Even though this reference is limited to the use of 1,6-hexamethylene diisocyanate, any aliphatic or cycloaliphatic isocyanate trimer may be prepared using the procedure therein. In the present invention, these trimers are generally preferred as the starting materials. Typically useful examples of such polyisocyanates containing isocyanurate groups are those formed from any of the conventional aliphatic and cycloaliphatic diisocyanates that are listed below. Preferred aliphatic trimers are those prepared from 1,6-hexamethylene diisocyanate which is sold under the tradename Desmodur® N-3300, are most preferred. Preferred cycloaliphatic isocyanate trimers are those prepared from isophorone diisocyanate which is sold under the tradename Desmodur® Z-4470.

Starting isocyanate trimers containing iminooxadiazine dione and optionally isocyanurate groups are also known and may be prepared in the presence of special fluorine-containing catalysts as described in U.S. Pat. Nos. 5,914,383, 6,107,484 and 6,090,939, herein incorporated by reference.

The other adduct groups, which have previously been described, may be incorporated in known manner either by separately preparing these adducts and then blending them with the polyisocyanate trimers containing isocyanurate and/or iminooxadiazine dione groups or by simultaneously preparing the other adduct groups.

For example, starting polyisocyanates containing isocyanurate groups and allophanate groups may be prepared simultaneously in accordance with the processes set forth in U.S. Pat. Nos. 5,124,427, 5,208,334 and 5,235,018, the disclosures of which are herein incorporated by reference. Examples of other starting polyisocyanates are those containing isocyanurate and urethane groups which may be prepared simultaneously from an organic polyisocyanate and a polyol. Any of the diisocyanates listed below can be used with a polyol to form such an adduct. Polyols such as trimethylol alkanes like trimethylol propane or ethane can be used.

Suitable methods for preparing polyisocyanates containing uretidione groups, urethane groups, allophanate groups, carbodiimide groups and oxadiazinetrione groups for subsequent blending with the polyisocyanates containing isocyanurate and/or iminooxadiazine dione groups to form the starting polyisocyanates are described in U.S. Pat. No. 6,096,823, the disclosure of which is herein incorporated by reference. These known polyisocyanates may also be blended with the polyisocyanate adducts according to the invention depending upon the particular application needs.

Any of the conventional aliphatic and cycloaliphatic diisocyanates can be used to form the desired polyisocyanate trimers listed above. Typically useful diisocyanates include, without limitation, 1,6-hexamethylene diisocyanate, 1,4-tetramethylene diisocyanate, isophorone diisocyanate, biscyclohexyl diisocyanate, tetramethyl xylylene diisocyanate, 1,4-cyclohexylene diisocyanate, bis-(4-isocyanatocyclohexyl)-methane, and the like.

The urea- and/or biuret-containing polyisocyanate adduct mixtures according to the invention have an isocyanate functionality of at least 4, preferably at least 4.5 and more preferably at least 4.8 and an NCO content of 10 to 24% by weight, preferably 12 to 22% by weight and more preferably 14 to 20% by weight, based on the weight of the polyisocyanate. The polyisocyanate adduct mixtures preferably have a maximum functionality of 10, more preferably 8 and most preferably 7. The products can be suitably reduced in solvent for use.

The inventors have surprisingly discovered that by chemically incorporating the slower reacting, relatively high T_{g} isophorone diisocyanate-based trimers into the polyisocyanate adduct mixture with the faster reacting, relatively low T_{g} hexamethylene diisocyanate-based trimers, the film T_{g} of the curing composition can be more quickly increased. While not wishing to be bound by any one particular theory, it is believed that the chemical mixture of an aliphatic polyisocyanate moiety and a cycloaliphatic polyisocyanate moiety in a single compound allows film-forming binders to build film T_{g} quickly, leading to faster processing times. It is known that the isocyanate groups of 1,6-hexamethylene diisocyanate (HDI) trimers react relatively quickly with crosslinkable film-forming binders but do not provide a high film T_{g} into the crosslinking film to allow a fast processability time. It is also known that isophorone diisocyanate (IPDI) trimers tend to react slowly with film-forming binders but provide relatively high film T_{g} when they do react. Similarly, it is known that a two component crosslinking system that uses HDI trimer as one component for fast crosslinking and IPDI trimer as the second component for its relatively high T_{g} forms coatings that initially have a relatively low film T_{g}. It is only after an extended curing time that the IPDI is able to crosslink into the system that the T_{g} rises appreciably.

In accordance with the invention, a portion of the HDI and IPDI trimers are chemically linked in the polyisocyanate adduct mixture. The wt % of linked product in the polyisocyanate adduct mixture, based on the weight of the polyisocyanate mixture, is preferably 5% to 80%, more preferably 7% to 70%, and most preferably 10% to 60%. In this way, every time that the fast-reacting moiety from a mixed linked adduct crosslinks into the film, a relatively high T_{g} moiety is also added to the film, thus rapidly increasing film T_{g}. This provides a crosslinking agent that can improve the dry-to-tape times significantly over the prior art. It was also unexpectedly found that coatings of the present invention have a gloss retention after tape of greater than 80%.

The curing agents are particularly suitable in coating compositions, especially in aviation coatings. In such applications, the polyisocyanate adducts may be used as is or may be blocked with any of the conventional blocking agents. Such products are also a part of this invention. Typical blocking agents are alcohols, ketimines, oximes and the like. Blocking agents are normally employed when formulating one-pack (1K) coatings.

The crosslinking agent in the present invention consists of from 5-95% by weight based upon the total weight of the crosslinking component of the previously described polyisocyanate adduct mixture and from 95% to 5% by weight based upon the total weight of the crosslinking component of at least one polyisocyanate compound that is different than the mixed polyisocyanate adduct. This second isocyanate compound is chosen from conventional di-, tri-, or higher polyisocyanates and are the same as those listed above. Preferred are the polyisocyanate trimers available from Bayer MaterialScience under the Desmodur® tradename.

The polyisocyanate adduct mixture crosslinking agent(s) described above can also be optionally combined with any of the conventional melamine curing agents for enhanced film integrity. Any of conventional monomeric or polymeric partially alkylated melamine formaldehyde melamine can be used, although monomeric alkoxy melamines are preferred. Typical alcohols that are used to alkylate these resins are methanol, ethanol, propanol, butanol, and the like. The details of such melamine resins suitable for use herein are described in Uhlianuk et al WO 00/55270 published Sep. 21, 2000, herein incorporated by reference. Preferred alkylated melamine crosslinking agents that are commercially available include Cymel® 373, Cymel® 385, and Cymel® 1168 resins. Cymel resins are available from Cytec Industries, West Paterson, N.J.

The coating compositions of this invention preferably are formulated into one- or two-pack liquid solvent borne or water borne coating compositions. Although the compositions are preferably liquid coating compositions, they may be formulated into powder coating compositions as well.

In the coating composition of the present invention, the aforementioned isocyanate or isocyanate/melamine component, also referred to herein as the activator, is typically stored separately from the other binder components prior to application. This results in a two-pack coating composition which is generally preferred.

The coating compositions of this invention generally contain a crosslinkable film-forming binder which comprises an isocyanate-reactive oligomer or polymer or dispersed gelled polymer, and a blocked or unblocked polyisocyanate adduct mixture as described above.

A typical solvent borne coating composition of this invention useful for finishing or refinishing basecoat/clear coat finishes for airplanes and other large vehicles or stationary equipment contains about 10% to 60% by weight of an organic liquid carrier and correspondingly, about 40% to 90% by weight of film forming binder. Preferably, the coating composition is a high solids composition that contains about 50 to 80% by weight of film-forming binder and 20% to 50% by weight of the organic liquid carrier. The coating composition is also preferably a low VOC composition that has a VOC content of less than 5 pounds of solvent per gallon and preferably in the range of about 2.0 to 4.5 pounds of solvent per gallon of coating composition, as determined under the procedure provide in ASTM D-3960. The film-forming binder contains about 10% to 90% by weight of a film-forming crosslinkable polymer, oligomer, or dispersed gelled polymer having functional components that are capable of reacting with isocyanate groups on the polyisocyanate crosslinking agent which comprises about 10% to 90% by weight of the binder.

As indicated above, the coating composition is particularly suited for use as a colorcoat in finishing or refinishing airplanes but can also be used as an undercoat such as a primer or sealer. These coatings may also be used in non-transportation applications such as in industrial and architectural applications.

The crosslinkable film forming binder is a polymeric, oligomeric, or dispersed gelled polymer composition that has moieties capable of crosslinking with isocyanate groups in the aforementioned polyisocyanates.

The crosslinkable oligomers useful in the coating composition have functional components capable of reacting with the isocyanate groups of the polyisocyanate adducts and a weight average molecular weight of about 200 to 2,000 and preferably have a polydispersity of less than 1.7.

Typically useful oligomers include hydroxy functional caprolactone oligomers which may be made by reacting caprolactone with a cyclic polyol. Particularly useful caprolactone oligomers are described on col. 4, line 3 to col. 5, line 2 of Lamb et al U.S. Pat. No. 5,286,782 issued Feb. 15, 1994, the disclosure of which is herein incorporated by reference. Other useful hydroxy functional oligomers are polyester oligomers such as an oligomer of an alkylene glycol, like propylene glycol, an alkane diol, like hexane diol, and an anhydride like methyl hexahydrophthalic anhydride reacted to a low acid number. These oligomers are described in Barsotti et al U.S. Pat. No. 6,221,494 issued Apr. 24, 2001, the disclosure of which is herein incorporated by reference. Other useful oligomers are hydroxy functional and are formed by reacting a monofunctional epoxy such as 1,2 epoxy butane with the below described acid functional oligomers using triethyl amine as a reaction catalyst resulting in very low (less than 20) acid number oligomers. The acid functional oligomers that are used as precursors for the hydroxy functional oligomers include, for example, an oligomer of a polyol such as pentaerythritol reacted with an anhydride such as methyl hexahydrophthalic anhydride to an acid number of about 30-300, preferably 150-250. The forgoing hydroxyl functional oligomers are described in Barsotti et al WO 99/05193 published Feb. 4, 1999, herein incorporated by reference.

Additional reactive oligomers include reactive silicon oligomers having a linear or branched cycloaliphatic moiety and at least two functional groups with at least one being a silane or a silicate group, the remaining being a hydroxyl group. Such silicon oligomers are described in Barsotti et al WO 99/40140 published Aug. 12, 1999, herein incorporated by reference. Other reactive oligomers include aldimine oligomers which are the reaction products of alkyl aldehydes, such as, isobutyraldehyde with diamines, such as isophorone diamine. Ketimine oligomers which are the reaction product of alkyl ketones, such as, methyl isobutyl ketone with diamines, such as, 2-methyl pentamethylene diamine. Polyaspartic esters, which are the reaction product of diamines, such as, isophorone diamine with dialkyl maleates, such as, diethyl maleate. Other useful oligomers are described in Barsotti et al WO 97/44402 published Nov. 27, 1997, the disclosure of which is herein incorporated by reference. All of the foregoing additional molecules are well known in the art.

Besides the oligomers, the crosslinkable binder for the coating composition may be an acrylic polymer or polyester having functional components capable of reacting with isocyanate groups of the polyisocyanate adduct mixtures. It is preferred to use such polymers in combination with any of the aforementioned oligomers for improved film integrity.

Typically useful acrylic polymers include acrylic polyols having a weight average molecular weight in the range from 2,000 to 50,000, preferably 3,000 to 20,000 and a T_{g} preferably in the range of 0C to 80° C, which are made from typical monomers such as acrylates, methacrylates, styrene and the like and functional monomers such as hydroxy ethyl acrylate, glycidyl methacrylate, or gamma methacryloyl propyl trimethoxy silane, t-butyl amino ethyl methacrylate, and the like. The details of acrylic polymers suitable for use in this invention are provided in Lamb et al. U.S. Pat. No. 5,286,782 issued Feb. 15, 1994, herein incorporated by reference.

A typical acrylic polymer is composed of polymerized monomers of styrene, a methacrylate which is either methyl methacrylate, isobornyl methacrylate, cyclohexyl methacrylate, or a mixture of these monomers and a second methacrylate monomer which is either isobutyl methacrylate, n-butyl methacrylate or ethyl hexyl methacrylate or a mixture of these monomers and a hydroxyl alkyl methacrylate or acrylate that has 1-4 carbon atoms in the alkyl group such as hydroxyl ethyl methacrylate, hydroxy propyl methacrylate, hydroxy butyl methacrylate, hydroxy ethyl acrylate, hydroxy propyl acrylate, hydroxyl butyl acrylate and the like.

One such acrylic polymer contains about 5% to 20% by weight of styrene, 10% to 30% by weight of the methacrylate, 30% to 60% by weight of the second methacrylate and 10% to 30% by weight of the hydroxy alkyl methacrylate. The total percentage of the monomers in the polymer equal 100%.

Another such acrylic polymer contains the following constituents in the above percentage ranges: 5% to 20% by weight of styrene, 10% to 30% by weight of methyl methacrylate, 30% to 60% by weight of isobutyl methacrylate or n-butyl methacrylate and 10% to 30% by weight of hydroxy ethyl methacrylate. The total percentage of the monomers in the polymer equal 100%.

Another such acrylic polymer contains the following constituents in the above percentage ranges: 5% to 20% by weight of styrene, 10% to 30% by weight of methyl methacrylate, 30% to 60% by weight of a mixture of isobornyl methacrylate/2-ethyl hexyl methacrylate/isobutyl methacrylate and 10% to 30% by weight of hydroxy ethyl methacrylate.

Other useful acrylic oligomers/polymers including acrylosilane polymers can also be used having a weight average molecular weight in the range from about 1,000 to 10,000, which are made from typical monomers such as methacrylates, acrylates, styrene, and functional monomers, such as hydroxy alkyl acrylate, hydroxy alkyl methacrylate, and an ethylenically unsaturated hydroxy functional acrylosilane.

One typical acrylosilane polymer is the polymerization product of an alkyl methacrylate, an alkyl acrylate each having 1 to 8 carbon atoms in the alkyl group, isobornyl methacrylate, styrene, hydroxy alkyl methacrylate having 1 to 4 carbon atoms in the alkyl group, and 5% to 40% by weight of an ethylenically unsaturated silane containing monomer, including alkoxysilanes such as vinylalkoxy silanes, for example, vinyl trimethoxy silane, vinyl triethoxy silane and vinyl tris (2-methoxyethoxy) silane, and the like. Other useful silane monomers are acyloxysilanes, including acrylatoxy silane, methacrylatoxy silane and vinylacetoxy silanes, such as vinylmethyl diacetoxy silane, acrylatopropyl triacetoxy silane, and methacrylatopropyltriacetoxy silane, and any mixtures thereof. The details of acrylosilane polymers useful herein are described in Lewin et al U.S. Pat. No. 5,684,084 issued Nov. 4, 1997, herein incorporated by reference.

Typically useful polyesters include polyester polyols having a weight average molecular weight in the range from 1,000 to 50,000, preferably from 2,000 to 5000 and a Tg preferably in the range from −50° C. to 100° C. The polyesters suitable for use in the invention are conventionally polymerized from suitable polyacids, including cycloaliphatic polycarboxylic acids, and suitable polyols, which include polyhydric alcohols. The details of polyesters suitable for use in this invention are provided in Hoffmann et al U.S. Pat. No. 5,326,820 issued Jul. 5, 1994, herein incorporated by reference. One of the commercially available polyester, which is particularly preferred, is SCD®-1040 polyester, which is supplied by Etna Product Inc., Chagrin Falls, Ohio.

Other film-forming polymers can also be used such as polyurethane polyols, acrylourethanes, polyester urethanes and polyether urethanes, and the like.

Dispersed gelled polymers (non aqueous dispersions) containing functional groups capable of reacting with isocyanate groups can also be used in the coating composition, preferably dispersed gelled acrylic polymers. Examples of hydroxy functional dispersed gelled acrylic polymers include acrylic polymers which have a core formed from polymerized monomers of methyl methacrylate, glycidyl methacrylate, methacrylic acid, methyl acrylate and stabilizing polymeric components formed from a macromonomer of styrene, butyl methacrylate, butyl acrylate, hydroxy ethyl acrylate, methacrylic acid, isobornyl methacrylate, and glycidyl methacrylate. The core is formed from a high molecular weight polymer having a weight average molecular weight of 50,000 to 500,000, preferably in the range of from 50,000 to 200,000. Arms, attached to the core, make up about 10 to 90 percent of the polymer and are formed from low molecular weight macromonomer having an average molecular weight of in the range from about 500 to 20,000, preferably 3,000 to 20,000. The details of dispersed gelled polymers which can be used in the present composition are provided in Barsotti et al. U.S. Pat. No. 5,763,528, herein incorporated by reference.

Mixtures of any of the aforementioned oligomers or polymers or dispersed gelled polymers can also be used.

The polyisocyanate curing agent used in the coating composition is a mixture of a) 5% to 95% by weight based upon the total weight of the crosslinking component of the polyisocyanate adduct mixture described above with b) 95% to 5% by weight based upon the total weight of the crosslinking component of at least one highly functional polyisocyanate that is different than a). The polyisocyanate is generally provided in an effective amount to rapidly cure the coating under ambient conditions (20° C.). The isocyanate reactive and polyisocyanate components are preferably employed in an equivalent ratio of isocyanate groups to hydroxyl groups of 0.5/1 to 3.0/1, more preferably 0.8/1 to 2.0/1. As described above, the polyisocyanate may be blocked or unblocked.

To improve weatherability of the clear composition about 0.1% to 10% by weight, based on the weight of the binder, of ultraviolet light stabilizers screeners, quenchers and antioxidants can be added. Typical ultraviolet light screeners and stabilizers include the following:

Benzophenones such as hydroxy dodecycloxy benzophenone, 2,4-dihydroxy benzophenone, hydroxy benzophenones containing sulfonic acid groups and the like.

Benzoates such as dibenzoate of diphenylol propane, tertiary butyl benzoate of diphenylol propane and the like.

Triazines such as 3,5-dialkyl-4-hydroxyphenyl derivatives of triazine, sulfur containing derivatives of dialkyl-4-hydroxy phenyl triazine, hydroxy phenyl-1,3,5-triazine and the like.

Triazoles such as 2-phenyl-4-(2,2′-dihydroxy benzoyl)-triazole, substituted benzotriazoles such as hydroxy-phenyltriazole and the like.

Hindered amines such as bis(1,2,2,6,6-pentamethyl-4-piperidinyl sebacate), di[4(2,2,6,6-tetramethyl piperidinyl)] sebacate and the like and any mixtures of any of the above.

The coating composition preferably contains sufficient amount of a catalyst or catalyst blend to cure the composition at ambient temperatures. Generally, about 0.01% to 2% by weight, based on the weight of the binder, of catalyst is used. Typically useful catalysts are tertiary amines such as triethylene diamine and alkyl tin esters such as dibutyl tin dilaurate, dibutyl tin diacetate, and the like. Typically, these are combined with acetic acid to improve the pot life of the composition.

Generally, flow control agents are used in the composition in amounts of about 0.1% to 5% by weight, based on the weight of the binder, such as polyacrylic acid, polyalkylacrylates, polyether modified dimethyl polysiloxane copolymer and polyester modified polydimethyl siloxane.

Conventional solvents and diluents are used to disperse and/or dilute the above mentioned polymers to obtain the present composition. Non-limiting examples of organic solvents that may be used in the present invention are, aliphatic, aromatic and/or cycloaliphatic hydrocarbons, alkyl esters of acetic acid or propionic acid, alkanols, ketones, glycol ethers and/or glycol ether esters and the like.

The applied coating composition can be used as a refinish or OEM coating, such as a color basecoat over which a clearcoat is applied, or the coating composition can be used as the clearcoat that is applied over a color basecoat, or it can be used as a single-stage pigmented basecoat, which has a glossy finish. It should be noted that clearcoat refers to the state of the dried and cured coating. It is possible that clearcoat composition, as applied, is a milky, or transparent, or opaque, or translucent solution, mixture, or dispersion. Also, clearcoat compositions can optionally have a small amount of pigment present in order to tint the cured clearcoat.

The substrates suitable for use in the present invention include those used in automobile applications, such as bodies; any and all items manufactured and painted by automobile sub-suppliers; frame rails; commercial trucks and truck bodies, including but not limited to beverage bodies, utility bodies, ready mix concrete delivery vehicle bodies, waste hauling vehicle bodies, and fire and emergency vehicle bodies, as well as any potential attachments or components to such truck bodies, buses, farm and construction equipment, truck caps and covers, commercial trailers, consumer trailers; recreational vehicles, including but not limited to, motor homes, campers, conversion vans, vans, pleasure vehicles, pleasure crafts, snow mobiles, all terrain vehicles, bicycles and motorcycles; and automotive interior and exterior plastic and metal components; marine applications, such as personal watercraft, ships, amphibious vehicles, and boats; aviation applications, such as land-based and sea-based aircraft, gliders and helicopters; residential and commercial applications, such as new construction and maintenance thereof, including but not limited to walls of commercial and residential structures, such office buildings and homes; amusement park equipment; concrete surfaces, such as parking lots and drive ways; asphalt and concrete road surface, wood substrates, marine structures, such as jetties, piers, and offshore oil rigs; outdoor structures, such as bridges, towers; coil coatings; oil, gas and water pipelines and pipe fittings; railroad cars; printed circuit boards; machinery; OEM tools; signage; fiberglass structures; MDF (medium density fiber) furniture, PVC flooring; sporting goods; sporting equipment; radiators; fences; oil filters; drive shafts; mirrors; gas cylinders; fuel tanks; aluminum and steel wheels; reinforcing steel rods; wirework, supermarket trolleys, valves, tubes, pipe heating systems, lamp posts and traffic poles, water tanks, and interior lining or exterior coating of fire extinguishers.

### EXAMPLES

Polyisocyanate Trimer 3300

An isocyanurate group-containing polyisocyanate prepared from 1,6-hexamethylene diisocyanate and having an isocyanate content of 21.8%, a content of monomeric diisocyanate of <0.2% and a viscosity at 20° C. of 2500 mPa·s (available from Bayer MaterialScience as Desmodur® N 3300).

Polyisocyanate Trimer 3600

An isocyanurate group-containing polyisocyanate prepared from 1,6-hexamethylene diisocyanate and having an isocyanate content of 23.0%, a content of monomeric diisocyanate of <0.25% and a viscosity at 25° C. of 1200 mPa·s (available from Bayer MaterialScience as Desmodur® N 3600).

Polyisocyanate Trimer 2294

An isocyanurate and iminooxadiazine dione group-containing polyisocyanate prepared from 1,6-hexamethylene diisocyanate and having an isocyanate content of 23.3%, a content of monomeric diisocyanate of <0.30% and a viscosity at 25° C. of 1000 mPa·s (available from Bayer MaterialScience as Desmodur® LS 2294).

Polyisocyanate Trimer 4470

An isocyanurate group-containing polyisocyanate prepared from isophorone diisocyanate and having an isocyanate content of 11.9%, a content of monomeric diisocyanate of <0.50% and a viscosity at 25° C. of 670 mPa·s as a 70% solution in n-butyl acetate (available from Bayer MaterialScience as Desmodur® Z 4470 BA).

Preparation of Urea and/or Biuret Group-Containing Polyisocyanates

### Example 1

A 3-liter 3-necked flask equipped with a cold water condenser, thermocouple, heating mantle, mechanical stirrer and nitrogen inlet was charged with 385 parts (2.1 eq) of Polyisocyanate trimer 2294 (polyisocyanate trimer A), 2200 parts (6.23 eq) of Polyisocyanate trimer 4470 (polyisocyanate trimer B), and 165 parts of n-butyl acetate (BAc). The mixture was stirred at room temperature under a nitrogen blanket until homogenous. 11.44 grams (1.91 eq) of distilled water and 1.30 grams of dibutyl phosphate (500 ppm of catalyst, based on polyisocyanate solids) were then added to the flask and the reaction mixture was heated to 140° C. After 8 hours, the reaction mixture was cooled to room temperature. The resulting product had an NCO content of 10.45 % (determined by potentiometric titration and a viscosity of 2894 cps at 70% weight solids in BAc (determined on a Brookfield RS Rheometer, (available from Brookfield Engineering, Middleboro, Mass.) at 25° C., 100 shear rate, for 4 minutes with a C50-1 spindle).

### Examples 2 Through 4

Examples 2-4 were prepared by the same method as Example 1 with the exception that in Examples 2-4 the reaction temperature varied between 120° C. to 140° C. and the reaction time varied between 8 to 9 hours. Details of Examples 2-4 are set forth in Table 1.

TABLE 1

| Example | 1 | 2 | 3 | 4 |
|---|---|---|---|---|
| Polyisocyanate trimer A | 2294 | 3600 | 3300 | 2294 |
| Polyisocyanate trimer B | 4470 | 4470 | 4470 | 0 |
| Polyisocyanate A/B | 1/4 | 1/4 | 1/4 | — |
| solids ratio | | | | |
| Polyisocyanate A, parts | 385 | 402.5 | 420 | 108 |
| Polyisocyanate A, eq | 2.10 | 2.20 | 2.18 | 267.69 |
| Polyisocyanate B, parts | 2200 | 2300 | 2400 | 0 |
| Polyisocyanate B, eq | 6.23 | 6.52 | 6.80 | 0 |
| Butyl Acetate, parts | 165 | 178 | 196 | 12 |
| % Solids | 70 | 70 | 70 | 90 |
| Water, parts | 11.44 | 10.96 | 12.58 | 0.77 |
| Water, eq | 1.91 | 1.83 | 2.10 | 58.21 |
| Catalyst, parts | 1.30 | 1.35 | 1.55 | 0.05 |
| % NCO | 10.45 | 10.36 | 10.4 | 17.32 |
| Viscosity (cps) | 2894 | 3625 | 3840 | 3231 |

### Coating Examples 5-30 and Comparative Coating Examples A-E

Table 2 shows the activation ratio, by volume, of the color composition (Dark blue Imron Elite Control available from DuPont, Wilmington, Del.) that is mixed with the isocyanate package. The isocyanate packages are mixed in the weight percentages as shown in table 2 and then mixed with the color composition. The catalyst package is added at the indicated ounces/gallon, and the composition is mixed. The viscosity of each mixture is evaluated after the initial mix, then at 30 minutes, and finally at 1 hour. Each coating is sprayed onto cleaned aluminum panels to hide a black/white hiding sticker. Each coating example was sprayed onto 4 individual panels, and allowed to dry at ambient temperature for either 1, 2, 3, or 4 hours. After the specified drying time, tape was applied to each panel. The tape was applied to each panel by hand using a squeegee. Tape strips were removed after 4, 24, 48, or 72 hours and evaluated for tape tracking. The results of the tape tracking evaluation is given in table 3. The tape used in each of these examples was Intertape Brand American Tape type PG777 manufactured by Intertape Polymer Group, Sarasota, Fla.

TABLE 2

| | Comparative | Comparative | Comparative | Comparative | Comparative |
|---|---|---|---|---|---|
| | coating A | coating B | coating C⁵ | coating D | coating E |
| Activation | 3/1 | 3/1 | 2/1 | 3/1 | 3/1 |
| ratio¹ | | | | | |
| Tolonate HDT | 100% | 100% | 100% | 100% | 100% |
| HR^{2,3} | | | (90% | | |
| | | | solids) | | |
| Example #1³ | 0 | 0 | 0 | 0 | 0 |
| Example #2³ | 0 | 0 | 0 | 0 | 0 |
| Example #3³ | 0 | 0 | 0 | 0 | 0 |
| Example #4³ | 0 | 0 | 0 | 0 | 0 |
| (90% solids) | | | | | |
| Catalyst⁴ | 1 oz | 2 oz | 10 oz | 1 oz | 2 oz |
| (ounces/gallon) | | | 389 s⁶ | | |

Zahn #2 (seconds)

| Initial | 22.32 | 30.53 | 30.35 | Not tested | Not tested |
|---|---|---|---|---|---|
| 30 minutes | 27.94 | 42.40 | 44.03 | | |
| 1 hour | 50.68 | >80 | 56.41 | | |
| 2 hours | | | gel | | |
| | Coating | Coating | Coating | Coating | Coating |
| | example | example | example | example | example |
| | 5 | 6 | 7 | 8 | 9 |
| Activation | 3/1 | 3/1 | 3/1 | 3/1 | 3/1 |
| ratio¹ | | | | | |
| Tolonate HDT | 70% | 70% | 70% | 70% | 60% |
| HR^{2,3} | | | | | |
| Example #1³ | 30% | 30% | 0 | 0 | 0 |
| Example #2³ | 0 | 0 | 30% | 30% | 40% |
| Example #3³ | 0 | 0 | 0 | 0 | 0 |
| Example #4³ | 0 | 0 | 0 | 0 | 0 |
| (90% solids) | | | | | |
| Catalyst⁴ | 1 oz | 2 oz | 1 oz | 2 oz | 2 oz |
| (ounces/gallon) | | | | | |

Zahn #2 (seconds)

| Initial | 22.03 | 26.50 | 21.34 | 29.50 | 23.72 |
|---|---|---|---|---|---|
| 30 minutes | 30.15 | 52.53 | 43.62 | 38.69 | 49.81 |
| 1 hour | 62 | gel | gel | gel | gel |
| | Coating | Coating | Coating | Coating | Coating |
| | example | example | example | example | example |
| | 10 | 11 | 12 | 13 | 14 |
| Activation | 3/1 | 3/1 | 3/1 | 3/1 | 3/1 |
| ratio¹ | | | | | |
| Tolonate HDT | 50% | 40% | 30% | 70% | 70% |
| HR^{2,3} | | | | | |
| Example #1³ | 0 | 0 | 0 | 0 | 0 |
| Example #2³ | 50% | 60% | 70% | 0 | 00 |
| Example #3³ | 0 | 0 | 0 | 30% | 30% |
| Example #4³ | 0 | 0 | 0 | 0 | 0 |
| 90% solids | | | | | |
| Catalyst⁴ | 2 oz | 2 oz | 2 oz | 1 oz | 2 oz |
| (ounces/gallon) | | | | | |

Zahn #2 (seconds)

| Initial | 25.78 | 21.15 | 27.53 | 25.62 | 28.75 |
|---|---|---|---|---|---|
| 30 minutes | 42.78 | 42.88 | 37.03 | 50.16 | 47.88 |
| 1 hour | gel | gel | gel | gel | gel |
| | Coating | Coating | Coating | Coating | Coating |
| | example | example | example | example | example |
| | 15 | 16 | 17 | 18 | 19 |
| Activation | 3/1 | 3/1 | 3/1 | 3/1 | 3/1 |
| ratio¹ | | | | | |
| Tolonate HDT | 70% | 60% | 50% | 40% | 30% |
| HR^{2,3} | | | | | |
| Example #1³ | 0 | 0 | 0 | 0 | 0 |
| Example #2³ | 0 | 0 | 0 | 0 | 0 |
| Example #3³ | 30% | 40% | 50% | 60% | 70% |
| Example #4³ | 0 | 0 | 0 | 0 | 0 |
| (90% solids) | | | | | |
| Catalyst⁴ | 2 oz | 2 oz | 2 oz | 2 oz | 2 oz |
| (ounces/gallon) | | | | | |

Zahn #2 (seconds)

| Initial | 20.18 | 27.91 | 21.50 | 30.53 | 24.16 |
|---|---|---|---|---|---|
| 30 minutes | 49.03 | 59.34 | 47.94 | 37.85 | 53.05 |
| 1 hour | gel | gel | gel | gel | gel |
| | Coating | Coating | Coating | Coating | Coating |
| | example | example | example | example | example |
| | 20 | 21 | 22 | 23 | 24 |
| Activation | 3/1 | 3/1 | 3/1 | 3/1 | 3/1 |
| ratio¹ | | | | | |
| Tolonate HDT | 0 | 0 | 0 | 90% | 85% |
| HR^{2,3} | | | | | |
| Example #1³ | 0 | 0 | 0 | 0 | 0 |
| Example #2³ | 0 | 0 | 0 | 0 | 0 |
| Example #3³ | 20% | 30% | 40% | 10% | 15% |
| Example #4³ | 80% | 70% | 60% | 0 | 0 |
| (90% solids) | | | | | |
| Catalyst⁴ | 2 oz | 2 oz | 2 oz | 2 oz | 2 oz |
| (ounces/gallon) | | | | | |

Zahn #2 (seconds)

| Initial | 23.34 | 18.93 | 23.94 | 22.34 | 18.12 |
|---|---|---|---|---|---|
| 30 minutes | 58.78 | 40.29 | 44.10 | gel | 38.19 |
| 1 hour | | | | | gel |
| | Coating | Coating | Coating | Coating | |
| | example | example | example | example | |
| | 25 | 26 | 27 | 28 | |
| Activation | 3/1 | 3/1 | 3/1 | 3/1 | |
| ratio¹ | | | | | |
| Tolonate HDT | 80% | 75% | 70% | 85% | |
| HR^{2,3} | | | | | |
| Example #1³ | 0 | 0 | 0 | 0 | |
| Example #2³ | 0 | 0 | 0 | 0 | |
| Example #3³ | 20% | 25% | 30% | 15% | |
| Example #4³ | 0 | 0 | 0 | 0 | |
| (90% solids) | | | | | |
| Catalyst⁴ | 2 oz | 2 oz | 2 oz | 2 oz | |
| (ounces/gallon) | | | | | |

Zahn #2 (seconds)

| | | | | |
|---|---|---|---|---|
| Initial | 22.40 | 19.75 | 23.88 | 24.84 |
| 30 minutes | 49.75 | 49.44 | 48.44 | gel |
| 1 hour | gel | gel | gel | |

¹The activation ratio is the ratio, by volume, of color composition/isocyanate
²Tolonate HDT is an HDI based isocyanurate available from Rhodia, Inc.
³All isocyanates are 70% solids, in butyl acetate, unless otherwise noted.
⁴The catalyst is 5% dibutyl tin dilaurate in ethyl acetate, Dibutyl tin dilaurate is available from Aldrich, Milwaukee, WI.
⁵8 ounces of BC Reducer 8971S, available from DuPont, Wilmington, DE was added to the isocyanate package of Comparative coating #3 prior to mixing with the Imron ® Elite Control color composition. Imron @ is available from DuPont, Wilmington, DE.
⁶Available as MasterTint ® 389S ™ from DuPont, Wilmington, DE

Tape tracking is a well-known defect in the industry and is caused by taping a paint before it has had a chance to thoroughly dry. Tape tracking can be seen as an imprinted line or texture in the dried cured paint film. The imprint left by the tape is rated visually. The results are summarized in Table 3.

TABLE 3

| | BC dry time prior to taping (hours) | | | |
|---|---|---|---|---|
| Tape | Comparative | Comparative | Comparative | Comparative |
| removed | coating A | coating B | coating C | coating E |

| after | 1 | 2 | 3 | 4 | 1 | 2 | 3 | 4 | 1 | 2 | 3 | 4 | 1 | 2 | 3 | 4 |
|---|---|---|---|---|---|---|---|---|---|---|---|---|---|---|---|---|
| 4 hrs | E | E | D | C | E | D | C | C | E | E | D | C | E | D | C | C |
| 24 hrs | E | E | D | C | E | D | C | C | E | E | D | C | E | D | C | C |
| 48 hrs | E | E | D | C | E | D | C | C | E | E | D | C | E | D | C | C |
| 72 hrs | E | E | D | C | E | D | C | C | E | E | D | C | E | D | C | C |

| Tape | BC dry time (hours) | | | |
|---|---|---|---|---|
| removed | Coating 1 | Coating 2 | Coating 3 | Coating 4 |

| after | 1 | 2 | 3 | 4 | 1 | 2 | 3 | 4 | 1 | 2 | 3 | 4 | 1 | 2 | 3 | 4 |
|---|---|---|---|---|---|---|---|---|---|---|---|---|---|---|---|---|
| 4 hrs | E | D | D | C | D | C | B | A | E | D | C | B | C | B | B | A |
| 24 hrs | E | D | D | C | D | C | B | A | E | D | C | B | C | B | B | A |
| 48 hrs | E | D | D | C | D | C | B | A | E | D | C | B | C | B | B | A |
| 72 hrs | E | D | D | C | D | C | B | A | E | D | C | B | C | B | B | A |

| Tape | BC dry time (hours) | | | |
|---|---|---|---|---|
| removed | Coating 13 | Coating 14 | Coating 15 | Coating 16 |

| after | 1 | 2 | 3 | 4 | 1 | 2 | 3 | 4 | 1 | 2 | 3 | 4 | 1 | 2 | 3 | 4 |
|---|---|---|---|---|---|---|---|---|---|---|---|---|---|---|---|---|
| 4 hrs | E | D | C | B | C | B | B | A | B | B | A | A | B | B | A | A |
| 24 hrs | E | D | C | B | C | B | B | A | B | B | A | A | B | B | A | A |
| 48 hrs | E | D | C | B | C | B | B | A | B | B | A | A | B | B | A | A |
| 72 hrs | E | D | C | B | C | B | B | A | B | B | A | A | B | B | A | A |

| Tape | BC dry time (hours) | | | |
|---|---|---|---|---|
| removed | Coating 17 | Coating 18 | Coating 19 | Coating 20 |

| after | 1 | 2 | 3 | 4 | 1 | 2 | 3 | 4 | 1 | 2 | 3 | 4 | 1 | 2 | 3 | 4 |
|---|---|---|---|---|---|---|---|---|---|---|---|---|---|---|---|---|
| 4 hrs | B | B | A | A | D | C | A | A | D | C | C | B | C | B | A | A |
| 24 hrs | B | B | A | A | D | C | A | A | D | C | C | B | C | B | A | A |
| 48 hrs | B | B | A | A | D | C | A | A | D | C | C | B | C | B | A | A |
| 72 hrs | B | B | A | A | D | C | A | A | D | C | C | B | C | B | A | A |

| Tape | BC dry time (hours) | | | |
|---|---|---|---|---|
| removed | Coating 21 | Coating 22 | Coating 23 | Coating 24 |

| after | 1 | 2 | 3 | 4 | 1 | 2 | 3 | 4 | 1 | 2 | 3 | 4 | 1 | 2 | 3 | 4 |
|---|---|---|---|---|---|---|---|---|---|---|---|---|---|---|---|---|
| 4 hrs | D | C | A | A | C | B | A | A | C | B | A | A | B | A | A | A |
| 24 hrs | D | C | A | A | C | B | A | A | C | B | A | A | B | A | A | A |
| 48 hrs | D | C | A | A | C | B | A | A | C | B | A | A | B | A | A | A |
| 72 hrs | D | C | A | A | C | B | A | A | C | B | A | A | B | A | A | A |

| Tape | BC dry time (hours) | | |
|---|---|---|---|
| removed | Coating 25 | Coating 26 | Coating 27 |

| after | 1 | 2 | 3 | 4 | 1 | 2 | 3 | 4 | 1 | 2 | 3 | 4 |
|---|---|---|---|---|---|---|---|---|---|---|---|---|
| 4 hrs | C | B | A | A | C | B | A | A | C | B | A | A |
| 24 hrs | C | B | A | A | C | B | A | A | C | B | A | A |
| 48 hrs | C | B | A | A | C | B | A | A | C | B | A | A |
| 72 hrs | C | B | A | A | C | B | A | A | C | B | A | A |

The results are ranked via a scale from A to E as follows;
A - Almost no tape mark visible
B - Very slight tape mark visible
C - Slight tape mark visible
D - Moderate tape mark visible
E - Severe tape mark visible
A rating of C (slight) or better is acceptable in the industry.

Coatings 29 and 30 were prepared using the same activation ratios, isocyanate package, and catalyst amounts as was used in Coating 24, with the following exceptions; Coating 29 used white Imron® Elite Control color composition, available from Dupont, Wilmington, Del., in place of the dark blue Imron Elite Control color composition, Coating 30 used Maroon Imron Elite Control color composition, available from Dupont, Wilmington, Del., in place of the dark blue Imron® Elite Control color composition. The gloss retention after tape of comparative coating C and coatings 24, 29, and 30 was measured using a BYK glossmeter available from BYK Gardner at 20 deg., 60 deg., and 85 deg. Two panels were sprayed for each coating composition. Initial gloss was measured after the basecoat had dried for 1 hour and two pieces of tape were applied to one of the panels by hand using a squeegee. The second panel was allowed to dry an additional 1 hour for a total dry time of 2 hours before being taped. One of the pieces of tape was removed after 4 hours from each panel and the second piece was removed after 24 hours.

Clearcoat binder

| Ingredient | Parts by weight |
|---|---|
| Acrylic Polyol resin¹ | 63.618 |
| Acetone | 3.046 |
| Oxo-oxtyl acetate² | 4.943 |
| Dimethyl esters of | 3.420 |
| succininc glutaric, and | |
| adipic acids³ | |
| Tinuvin 384⁴ | 1.392 |
| Tinuvin 292⁴ | 0.847 |
| Silica dispersion⁵ | 11.086 |
| Methyl amyl ketone | 5.942 |
| NAD resin⁶ | 5.433 |
| ¹Acrylic Polyol resin is a polymer having a weight percentage composition of styrene (15)/butyl methacrylate (30)/butyl acrylate (17)/hydroxy propyl acrylate (38) made by a conventional free-radical polymerization using tert-butyl peroxy acetate as the initiator at 70% solids in methyl amyl ketone. | |
| ²Available from Aldrich, Milwaukee, WI. | |
| ³Available from Invista, Wilmington, DE. | |
| ⁴Available from Ciba Speciality Chemicals Corp, Tarrytown, NY. | |
| ⁵Available from Accurate Chemical and Scientific Corporation, Westbury, NY. | |
| ⁶NAD resin is produced as follows; | |
| Polymer 1-A reactor is charged with 13.79 parts by weight (pbw) of methyl methacrylate, 4.25 pbw of a methylmethacrylate/glycidyl methacrylate copolymer (available from PPG Industries as Super Stabilizer HCM-8788), 88.63 pbw Varasol 18 (available from ExxonMobil), 1.27 pbw 2,2-(2-methylbutane nitrile), and 66.86 pbw heptane. The mixture is heated to 98° C. Over a period of 6 hours, a mixture of 31.64 pbw heptane, 0.54 pbw N,N-dimethyl ethanolamine, 252.15 pbw | |
| #methylmetharcylate/glycidyl methacrylate, 52.91 pbw methylm methacrylate copolymer (available from PPG Industries as Super Stabilizer HCM-8788), 2.57 pbw glycidyl methacrylate, 2.57 pbw methacrylic acid, and 146.85 pbw Varasol 18 (available from ExxonMobil) was added to the reactor. Concurrently with the above addition is added a mixture of 11.75 pbw toluene, 1.84 pbw 2,2-(2-methylbutane nitrile), and 23.95 pbw of heptane was added. When the additions were complete, the reaction was held at 98° C. | |
| #for 3 hours then cooled to room temperature. | |
| NAD resin - 466.53 pbw of polymer 1 is added to a reactor and the mixture was heated to 107° C. A mixture of 55.43 pbw hydroxypropyl methacrylate, 9.01 pbw of a methylmethacrylate/glycidyl methacrylate copolymer (available from PPG Industries as Super Stabilizer HCM-8788), 83.12 pbw of butyl methacrylate, and 1 pbw of heptane was added to the reactor over 3 hours. Concurrently with this addition was added 8.77 pbw toluene, 7.74 pbw 2,2-(2-methylbutane nitrile), and 0.78 | |
| #pbw heptane over a 3 hour period. Concurrently with this addition, was added a mixture of 6.20 pbw N-octyl mercaptan in 4.02 pbw heptane over 3 hours. When the additions were complete, the reaction was held at 107° C. for 2 hours then cooled to room temperature. | |

The ingredients of the clearcoat binder were added, in order and with stirring, to a metal can to produce a clearcoat binder composition.

Clearcoat activator

| Ingredient | Parts by weight |
|---|---|
| Desmodur XP 2410¹ | 75.00 |
| 2-Ethylhexyl acetate² | 18.425 |
| Methyl amyl ketone² | 6.575 |

¹Desmodur XP 2410 is available from Bayer MaterialScience, Pittsburgh, PA.
²Available from Aldrich, Milwaukee, WI.

The ingredients of the clearcoat activator were added in order with stirring to a metal can to produce a clearcoat activator formulation.

Three parts of the clearcoat binder and two parts of the clearcoat activator were mixed with stirring to produce a clearcoat composition. The clearcoat composition was applied to the panels having comparative coating C and coatings 24, 29, and 30. The coating were dried (how?) and evaluated for gloss.

The panels were then sprayed with a clearcoat composition. The gloss of each panel was measured taking care to measure gloss where the tape had been placed. Gloss after tape is an average of the 4 and 24 hour tape times. The gloss was measured at the same angles, 20 deg., 60 deg., and 85 deg. The results are given in table 4 as a percentage of gloss retained from the initial gloss, by the equation:
(1−(Glossᵢₙᵢₜᵢₐₗ−Gloss_{after tape})/Glossᵢₙᵢₜᵢₐₗ)×100=% retention

TABLE 4

| | Comparative | Coating | Coating | Coating |
|---|---|---|---|---|
| | Coating C | 24 | 29 | 30 |
| Initial gloss | 82.8 | 86.4 | 86.5 | 84.9 |
| 20 deg. | | | | |
| % 20 deg. gloss | 5.9 | 99.0 | 97.3 | 84.7 |
| retention (after | | | | |
| 1 hour dry time) | | | | |
| % 20 deg. gloss | 38.9 | 98.7 | 100 | 99.3 |
| retention (after | | | | |
| 2 hours dry time) | | | | |
| Initial gloss | 92.3 | 92.3 | 95.0 | 91.6 |
| 60 deg. | | | | |
| % 60 deg. gloss | 14.8 | 99.6 | 99.8 | 97.8 |
| retention (after | | | | |
| 1 hour dry time) | | | | |
| % 60 deg. gloss | 60.9 | 99.6 | 100 | 99.3 |
| retention (after | | | | |
| 2 hours dry time) | | | | |
| Initial gloss | 98.4 | 98 | 97.7 | 97.3 |
| 85 deg. | | | | |
| % 85 deg. gloss | | | | |
| retention (after | 30.3 | 100 | 100 | 96.9 |
| 1 hour dry time) | | | | |
| % 85 deg. gloss | 74.7 | 98.8 | 100 | 99.9 |
| retention (after | | | | |
| 2 hours dry time) | | | | |

1. An ultraproductive coating composition comprising a film forming crosslinkable component and a crosslinking component wherein said crosslinking component comprises
(a) 5-95% by weight based upon the total weight of the crosslinking component of a polyisocyanate adduct mixture and
(b) 95-5% by weight based upon the total weight of the crosslinking component of at least one other crosslinking component selected from the group diisocyanates and/or polyisocyanates,
wherein said film forming crosslinkable component comprises a polymer, oligomer, or a dispersed gelled polymeric material that has functional groups that are crosslinkable with isocyanate groups of said crosslinking component and the gloss retention after tape of said coating is at least 80%.

2. The composition according to claim 1 wherein said polyisocyanate adduct mixture comprises at least one aliphatic polyisocyanate trimer and at least one cycloaliphatic polyisocyanate trimer.

3. The composition of claim 2, wherein said non-cycloaliphatic polyisocyanate trimer is derived from hexamethylene diisocyanate and said cycloaliphatic polyisocyanate trimer is derived from isophorone diisocyanate.

4. The composition of claim 2, wherein said non-cycloaliphatic polyisocyanate trimer is derived from hexamethylene diisocyanate.

5. The composition of claim 2, wherein said cycloaliphatic polyisocyanate trimer is derived from isophorone diisocyanate.

6. The coating composition of claim 1 wherein said other crosslinking component (b) is a polyisocyanate derived from 1,6-hexamethylene diisocyanate.

7. The coating composition of claim 1, wherein the dry to tape time at ambient temperature after the composition is applied to a suitable substrate is less than or equal to 1 hour (minutes?).

8. The coating composition of claim 1 used as a primer.

9. The coating composition of claim 1 used as a basecoat in a basecoat/clearcoat paint system.

10. The coating composition of claim 1 used as a clearcoat in a basecoat/clearcoat paint system.

11. The coating composition of claim 1 used as a single-stage basecoat finish.

12. The coating composition of claim 2 wherein the weight ratio of non-cycloaliphatic polyisocyanate trimer to cycloaliphatic polyisocyanate trimer is 1:4.

13. The coating composition of claim lwherein said composition contains 10-20% of component (a) and 80-90% of component (b).

14. A substrate coated with a dried, cured layer of the coating composition of claim 1.

15. A substrate coated with at least one dried, cured layer of the coating composition of claim 1.

16. An aviation substrate coated with at least one layer of a dried cured layer of the coating composition of claim 1.

17. A process for producing a coating on the surface of a substrate wherein the process comprises the steps of
a) applying a layer of pigmented basecoat on the surface of said substrate,
b) applying a layer of a clearcoat on said pigmented basecoat; and
c) drying and curing the basecoat and clearcoat layers wherein, the pigmented basecoat comprises a film-forming crosslinkable component, a crosslinking component, and at least one pigment, wherein said crosslinking component comprises (i) 5% to 95% by weight based upon the total weight of the crosslinking component of a polyisocyanate adduct mixture and (ii) 95% to 5% by weight based upon the total weight of the crosslinking component of at least one other crosslinking component selected from the group diisocyanates or polyisocyanates, wherein said dried and cured layer has a gloss retention after tape of at least 80%.
